(19) United States
(12) Patent Application Publication
(10) Pub. No.: US 2026/0189033 A1
(43) Pub. Date: Jul. 2, 2026

(54) CELL ELECTRICITY QUANTITY BALANCING MODULE, ELECTRICITY QUANTITY BALANCING METHOD, AND HEATING METHOD AND APPARATUS

(71) Applicant: Beijing Institute of Aerospace Launch Technology, Beijing (CN)

(72) Inventors: Huan XIA, Beijing (CN); Hui WANG, Beijing (CN); Feng GAO, Beijing (CN); Hongzhi ZHAO, Beijing (CN); Zhigang ZHAO, Beijing (CN); Gang HE, Beijing (CN); Zhiwei LUO, Beijing (CN); Jiapeng GONG, Beijing (CN); Jing ZHAO, Beijing (CN); Sushuang LI, Beijing (CN); Yan WANG, Beijing (CN); Weiyang WANG, Beijing (CN); Jinbo YANG, Beijing (CN); Yufei JIANG, Beijing (CN); Xingyan DONG, Beijing (CN); Baoli XU, Beijing (CN); Shengzhuang SONG, Beijing (CN); Chao LI, Beijing (CN); Shiye CHEN, Beijing (CN); Yuhang LIU, Beijing (CN); Jin ZHANG, Beijing (CN); Weijian LU, Beijing (CN); Chenliang AN, Beijing (CN); Shicheng LIU, Beijing (CN); Bo MA, Beijing (CN); Lutong WANG, Beijing (CN); Meifang XUE, Beijing (CN)

(21) Appl. No.: 18/855,643

(22) PCT Filed: Oct. 10, 2023
(86) PCT No.: PCT/CN2023/123735

§ 371 Date: Oct. 10, 2024

(30) Foreign Application Priority Data
Mar. 2, 2023 (CN) 202310192007.7

(51) Int. Cl. H02J 7/56

(52) U.S. Cl. CPC H02J 7/56

(57) ABSTRACT

Disclosed are a cell electricity quantity balancing module, a balancing method, a heating method and an apparatus, solving problems of complex circuits, poor flexibility, and inability to balance thermal management in the prior art. The module includes two cell side coils, a balancing coil, and three DC/AC converters corresponding to coils, where an AC terminal of a first DC/AC converter is connected in parallel with one cell side coil, a DC terminal is connected in parallel with positive and negative poles of a first adjacent cell; an AC terminal of a second DC/AC converter is connected in parallel with the other cell side coil, a DC terminal is connected in parallel with positive and negative poles of a second adjacent cell; and an AC terminal of a third DC/AC converter is connected in parallel with the balancing coil, a DC terminalis connected in parallel with a direct currentbus.

The present disclosure claims priority to Chinese Patent Application No. 2023101920077, filed on Mar. 2, 2023 and entitled “CELL ELECTRICITY QUANTITY BALANCING MODULE, ELECTRICITY QUANTITY BALANCING METHOD, HEATING METHOD AND APPARATUS”, the disclosure of which is herein incorporated by reference in its entirety.

### TECHNICAL FIELD

The present disclosure relates to the field of power battery technologies and, in particular, to a cell electricity quantity balancing module, an electricity quantity balancing method, and a heating method and an apparatus.

### BACKGROUND

The prior art of cell electricity quantity balancing in a lithium-ion battery pack includes passive balancing and active balancing. The active balancing means that a cell with low electricity quantity is recharged to achieve electricity quantity balancing between each cell in a battery pack. The active balancing generally adopts a DC (direct current)/DC conversion technology. A high voltage side is connected in parallel to positive and negative poles of the entire battery pack, and a low voltage side uses a cell switching matrix to select a cell that needs to be balanced. An isolation transformer is used to transfer energy from the high voltage side to the low voltage side and isolate high and low voltage levels. The DC/DC conversion technology requires design of a complex cell switching matrix circuit and switching logic. The volume of transformer is positively correlated with a design value of balancing current, and the number of cell circuits that can be balanced at the same time is positively correlated with the number of transformers. It is not easy to balance multiple circuits at the same time.

It is feasible to apply wireless power transmission technologies to the active balancing of cell electricity quantity. Yang proposed a balancing circuit utilizing wireless power transmission in 2014, but a coil occupies a large volume, resulting in low energy density and transmission efficiency of a finished battery pack product. Liu proposed a circuit topology in 2020 in which multiple cells share one WPT (wireless power transmission) coil, but cannot be balanced at the same time. Additionally, a circuit from the WPT coil to each cell still adopts a longer wire to connect, resulting in a heavier weight. Furthermore, alternating current on the wire can be radiated to a BMS circuit, causing interference to the BMS circuit. Eashwar proposed an inter cell balancing circuit in 2020, but the circuit topology is too complex, leading to decreased reliability and increased costs. Additionally, a complex circuit occupies the large volume, leading to the lower energy density of the battery pack in a final state.

In application of the lithium-ion battery pack, it is also necessary to consider balancing working temperature of the cell. The cell used in a low-temperature environment needs to be heated and maintained at the working temperature to ensure safety and performance of the cell. In thermal management technologies of the lithium-ion battery pack, heating measures include air heating and liquid heating with low thermal efficiency, as well as heating element heating that rapidly heats up. The heating element is generally connected in series between total positive and total negative of the battery pack, and is turned on or off by controlling a relay. The temperature of the battery pack is controlled within a certain temperature hysteresis interval, but it is difficult to accurately control the temperature of the battery pack. In addition, due to different heat dissipation rates of cells in different positions within the battery pack, there is a large temperature difference between the cells in different areas, affecting consistency of performance between the cells. In seasons that the temperature is not low, the heating element does not need to be turned on, but it cannot be disassembled, becoming an idle and useless component of the battery pack for a certain period of time.

### SUMMARY

To solve the above problems in the prior art, embodiments of the present disclosure provide a cell electricity quantity balancing module, an electricity quantity balancing method, and a heating method and an apparatus.

To achieve the above purpose, the present disclosure adopts the following technical solutions.

In the first aspect, the present disclosure provides a cell electricity quantity balancing module, including:
two cell side coils, a balancing coil, and three DC/AC (alternating current) converters corresponding to coils, where an AC terminal of a first DC/AC converter is connected in parallel with one cell side coil, and a DC terminal is connected in parallel with positive and negative poles of a first adjacent cell; an AC terminal of a second DC/AC converter is connected in parallel with the other cell side coil, and a DC terminal is connected in parallel with positive and negative poles of a second adjacent cell; an AC terminal of a third DC/AC converter is connected in parallel with the balancing coil, and a DC terminal is connected in parallel with a direct current bus; and the two cell side coils are located on both sides of the balancing coil, and the cell side coil is bonded to the balancing coil in an insulated manner.

In a second aspect, the present disclosure provides a cell electricity quantity balancing method, including:
determining a cell electricity quantity balancing module provided between paired associated cells;
acquiring a voltage signal of each cell in a battery pack, and determining an electricity quantity deviation cell that needs to balance electricity quantity according to an electricity quantity balancing strategy; and
locating a corresponding cell electricity quantity balancing module according to the electricity quantity deviation cell, and controlling the cell electricity quantity balancing module to perform cell electricity quantity balancing at the same time according to a voltage working condition of the associated cell until a balancing cut-off condition is met.

Further, controlling the cell electricity quantity balancing module to perform the cell electricity quantity balancing at the same time according to the voltage working condition of the associated cell includes:
determining a first working condition of electricity quantity balancing when the electricity quantity of at least one of the two associated cells corresponding to the cell electricity quantity balancing module is lower than an electricity quantity demand threshold; and
controlling a DC/AC converter corresponding to a balancing coil to work in an inverter mode through the cell electricity quantity balancing module according to the first working condition, and controlling the DC/AC converter corresponding to a cell side coil of the associated cell below the electricity quantity demand threshold to work in a rectification mode.

Further, controlling the cell electricity quantity balancing module to perform the cell electricity quantity balancing at the same time according to the voltage working condition of the associated cell includes:
determining a second working condition of the electricity quantity balancing when the electricity quantity of one of the two associated cells corresponding to the cell electricity quantity balancing module is lower than a lower limit of the electricity quantity demand threshold and the electricity quantity of the other cell is higher than an upper limit of the electricity quantity demand threshold; and
controlling the DC/AC converter corresponding to the cell side coil of the associated cell below the electricity quantity demand threshold to work in the rectification mode through the cell electricity quantity balancing module according to the second working condition, and controlling the DC/AC converter corresponding to the cell side coil of the associated cell above the electricity quantity demand threshold to work in the inverter mode.

Further, controlling the cell electricity quantity balancing module to perform the cell electricity quantity balancing at the same time according to the voltage working condition of the associated cell includes:
determining a third working condition of the electricity quantity balancing when the electricity quantity of the two associated cells corresponding to the cell electricity quantity balancing module is higher than the electricity quantity demand threshold; and
controlling DC/AC converters of cell side coils of the two associated cells to respectively work in the inverter mode through the cell electricity quantity balancing module according to the third working condition, and controlling the DC/AC converter corresponding to the balancing coil to work in the rectification mode.

In a third aspect, the present disclosure provides a cell heating method, including:
acquiring a temperature signal of each cell in a battery pack, and determining a temperature compensation cell that needs to be heated according to a temperature threshold;
determining a fourth working condition of the temperature compensation cell according to a cold threshold in the temperature threshold; and
controlling DC/AC converters of two associated cells to perform complementary mode switching through a cell electricity quantity balancing module corresponding to the temperature compensation cell according to the fourth working condition.

In a fourth aspect, the present disclosure provides a cell heating method, including:
acquiring a temperature signal of each cell in a battery pack, and determining a temperature compensation cell that needs to be heated according to a temperature threshold;
determining a fifth working condition of the temperature compensation cell according to a low temperature threshold in the temperature threshold; and
controlling DC/AC converters corresponding to cell side coils of two associated cells to work in an inverter mode through a cell electricity quantity balancing module corresponding to the temperature compensation cell according to the fifth working condition.

Further, the cell heating method further includes:
acquiring a voltage signal of each cell in the battery pack when the temperature of the temperature compensation cell reaches a heating cut-off condition, so as to determine whether it is necessary to perform cell electricity quantity balancing.

In a fifth aspect, the present disclosure provides a cell heating method, including:
acquiring a temperature signal of each cell in a battery pack, and determining a temperature compensation cell that needs to be heated according to a temperature threshold;
determining a sixth working condition of the temperature compensation cell according to a distribution area of the temperature compensation cell; and
controlling a DC/AC converter corresponding to a balancing coil to work in an inverter mode through a cell electricity quantity balancing module in the distribution area according to the sixth working condition.

In a sixth aspect, the present disclosure provides a cell electricity quantity balancing apparatus, including:
a circuit determining submodule configured to determine a cell electricity quantity balancing module provided between paired associated cells;
a cell determining submodule configured to acquire a voltage signal of each cell in a battery pack, and determine an electricity quantity deviation cell that needs to balance electricity quantity according to an electricity quantity balancing strategy; and
an electricity quantity balancing submodule configured to locate a corresponding cell electricity quantity balancing module according to the electricity quantity deviation cell, and control a cell electricity quantity balancing module to perform cell electricity quantity balancing at the same time according to a voltage working condition of the associated cell until a balancing cut-off condition is met.

In a seventh aspect, the present disclosure provides a readable medium, where the readable medium includes execution instructions, when executed by a processor of an electronic device, the electronic device performs the method described above.

In an eighth aspect, the present disclosure provides an electronic device, where the electronic device includes a processor and a memory storing execution instructions, when the execution instructions stored in the memory are executed by the processor, the processor performs the method described above.

The cell electricity quantity balancing module, the electricity quantity balancing method, the heating method, and the apparatus in the embodiments of the present disclosure can discharge and recharge the cell with high or low electricity quantity in the entire battery pack, achieving multi-channel simultaneous electricity quantity balancing, and avoiding drawbacks of large balancing heating and few active balancing channels. According to a principle of wireless power transmission (WPT), isolation between WPT coils is adopted without the need to isolate a transformer. In addition to being used for the electricity quantity balancing, a coil can also be used as a cell heating coil, fully utilizing the coil. When controlling heating of the battery pack, the cell electricity quantity balancing module is used as a minimum unit, each cell electricity quantity balancing module can independently and accurately control temperature, and temperature uniformity of the entire battery pack is good.

### BRIEF DESCRIPTION OF THE DRAWINGS

For clearer description of technical solutions according to embodiments of the present disclosure or the prior art, drawings to be referred to for the description of the embodiments or the prior art are briefly described below. Apparently, the drawings in the description below merely illustrate some embodiments recorded in the present disclosure, and those ordinary skilled in the art can further derive other drawings according to the drawings without creative labor.

FIG. 1 shows a schematic structural diagram of a cell quantity electricity balancing module according to an embodiment of the present disclosure.

FIG. 2 shows a practical application diagram of a cell quantity electricity balancing module according to an embodiment of the present disclosure.

FIG. 3 shows a flowchart of a cell quantity electricity balancing method according to an embodiment of the present disclosure.

FIG. 4 shows a flowchart of practical application of a cell quantity electricity balancing method according to an embodiment of the present disclosure.

FIG. 5 shows a flowchart of a cell heating method according to an embodiment of the present disclosure.

FIG. 6 shows an architecture diagram of a cell quantity electricity balancing apparatus according to an embodiment of the present disclosure.

### DETAILED DESCRIPTION

To make technical objects, technical solutions, and beneficial effects of the present disclosure clearer, specific implementation manners of the present disclosure are described clearly and completely below with reference to drawings. The specific implementation manners described are merely some of embodiments of the present disclosure, not all of the embodiments. According to the specific implementation manners of the present disclosure, other embodiments acquired by those skilled in the art without creative labor all belong to a protection scope of the present disclosure.

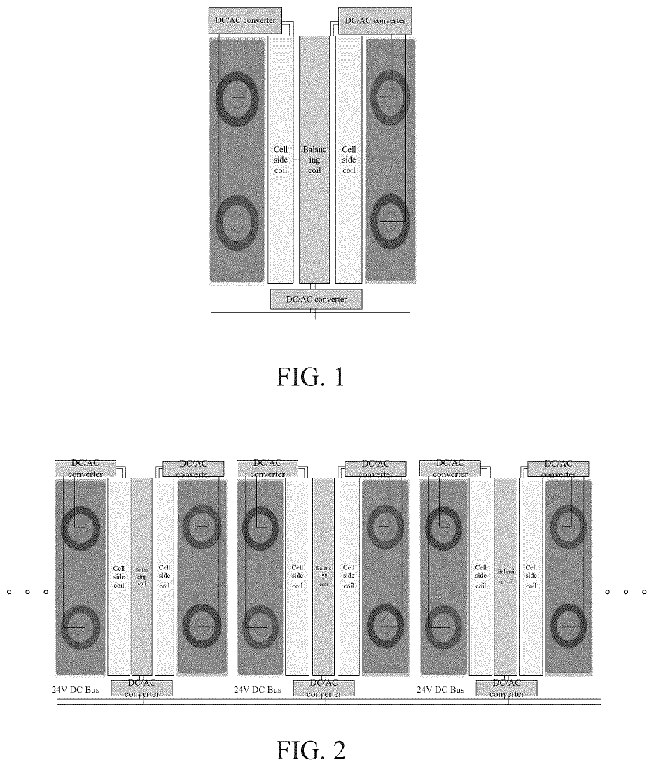

A cell electricity quantity balancing module according to an embodiment of the present disclosure is shown in FIG. 1. In FIG. 1, the embodiments of the present disclosure include two cell side coils, a balancing coil, and three DC/AC converters corresponding to coils. An AC terminal of a first DC/AC converter is connected in parallel with one cell side coil, and a DC terminal is connected in parallel with positive and negative poles of a first adjacent cell. An AC terminal of a second DC/AC converter is connected in parallel with the other cell side coil, and a DC terminal is connected in parallel with positive and negative poles of a second adjacent cell. An AC terminal of a third DC/AC converter is connected in parallel with the balancing coil, and a DC terminal is connected in parallel with a direct current bus. Two cell side coils are located on both sides of the balancing coil, and the cell side coil is bonded to the balancing coil in an insulated manner.

The cell side coil and the balancing coil are electromagnetic induction coils, and specific coil parameters comply with corresponding wireless charging technical standards. A DC/AC converter, also known as a bidirectional inverter, has an inverter (mode) capability of converting from DC to AC and a rectifier (mode) capability of rectifying from AC to DC, and has connecting terminals for both a direct current DC terminal and an alternating current AC terminal. A load current of the direct current bus is typically 24V. The cell side coil is coaxial with the balancing coil. Three coils, as a structural unit of a composite layer, are located in an adjacent gap between a pair of associated cells.

Each coil in the above cell electricity quantity balancing module will generate a thermal effect when carrying a high-frequency alternating current signal. Through reasonable design of working condition control, a heating heat source can be used as a cell, enabling the cell electricity quantity balancing module to serve as a cell balancing and heating module (CBHM, hereinafter referred to as module or CBHM) in a lithium-ion power battery pack.

Practical application of the cell electricity quantity balancing module in an embodiment of the present disclosure is shown in FIG. 2. In FIG. 2, every two adjacent cells are equipped with one cell electricity quantity balancing module, and all balancing coils are connected in parallel to a 24 VDC bus through corresponding DC/AC converters. The electricity quantity of each cell in the battery pack is analyzed by collecting voltage and current signals. The cell electricity quantity balancing module is used to control charging of the cell with low electricity quantity and discharging of the cell with high electricity quantity. The discharged electricity quantity can be recovered or converted through the direct current bus.

The cell electricity quantity balancing module in the embodiments of the present disclosure establishes an energy electromagnetic induction transmission path between the direct current bus and the cell, as well as between cells, using an induction coil. A controlled logic for supplied electrical energy direction conversion is formed through a DC/AC converter. The controlled logic not only can achieve accurate charging and discharging control of the electricity quantity for a single cell during an electricity quantity balancing process, but also can also serve as a distributed electricity quantity balancing node for the battery pack, forming multi-channel simultaneous active balancing of the electricity quantity between different cells. While effectively improving charging and discharging performance and increasing a service life of the battery pack, the controlled logic avoids increasing difficulty of assembling circuit components, reduces size and weight of the battery pack, and improves energy density of the battery pack in a final state.

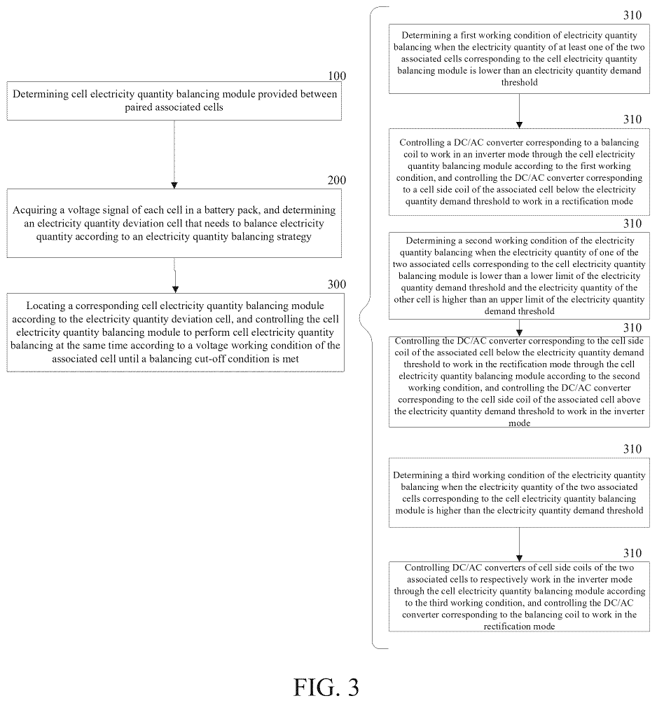

A cell electricity quantity balancing method according to an embodiment of the present disclosure is shown in FIG. 3. In FIG. 3, the embodiments of the present disclosure utilize the cell electricity quantity balancing module according to the above embodiments, including the following steps.

At step 100, a cell electricity quantity balancing module provided between paired associated cells is determined.

The connection between the cell electricity quantity balancing module and pairs of adjacent cells and the direct current bus is described in a specific connection structure according to the above embodiments. A mapping between the associated cell and the cell electricity quantity balancing module is formed.

At step 200, a voltage signal of each cell in a battery pack is acquired, and an electricity quantity deviation cell that needs to balance electricity quantity is determined according to an electricity quantity balancing strategy

The acquisition of the voltage signal utilizes an existing voltage signal acquisition subsystem in the battery pack. A potential difference reflected by the voltage signal forms a necessary mapping between each cell electricity quantity balancing module, the cell, and the cell electricity quantity in the battery pack. Furthermore, the electricity quantity deviation cell that deviates from an electricity quantity demand (too large or too small) is determined according to an electricity quantity demand threshold set by the electricity quantity balancing strategy. In an embodiment of the present disclosure, the electricity quantity balancing strategy includes an electricity quantity demand threshold of a stable output power of the battery pack for each cell formed according to a power output demand, cell charging and discharging parameters, and battery pack heat dissipation quantification parameters. In an embodiment of the present disclosure, the electricity quantity demand threshold can be set as an average electricity quantity of the cell in the battery pack. In an embodiment of the present disclosure, the electricity quantity demand threshold is an interval range with an upper limit and a lower limit.

At step 300, a corresponding cell electricity quantity balancing module is located according to the electricity quantity deviation cell, and the cell electricity quantity balancing module is controlled to perform cell electricity quantity balancing at the same time according to a voltage working condition of the associated cell until a balancing cut-off condition is met.

There is diversity in an electricity quantity difference between the two associated cells in the same cell electricity quantity balancing module, resulting in different voltage working conditions between the associated cells. The cell electricity quantity balancing module forms a corresponding electricity quantity balancing control process according to characteristics of the working condition. The electricity quantity demand threshold of the electricity quantity balancing strategy for each cell can serve as the balancing cut-off condition for electricity quantity balancing.

The cell electricity quantity balancing method in the embodiments of the present disclosure fully utilizes a flexible control mechanism of the cell electricity quantity balancing module on a wireless power transmission direction to form accurate electricity quantity balancing control that adapts to the voltage working condition of the associated cell. During the electricity quantity balancing process, the cell electricity quantity balancing module can form simultaneous electricity quantity balancing for the electricity quantity deviation cell according to the electricity quantity balancing strategy, fully ensuring efficiency of the electricity quantity balancing and overall electricity quantity balancing accuracy of the cell.

As shown in FIG. 3, in an embodiment of the present disclosure, the cell electricity quantity balancing module performs the cell electricity quantity balancing at the same time according to the voltage working condition of the associated cell, including the following steps.

At step 310, a first working condition of electricity quantity balancing is determined when the electricity quantity of at least one of the two associated cells corresponding to the cell electricity quantity balancing module is lower than an electricity quantity demand threshold.

At step 320, a DC/AC converter corresponding to a balancing coil is controlled to work in an inverter mode through the cell electricity quantity balancing module according to the first working condition, and the DC/AC converter corresponding to a cell side coil of the associated cell below the electricity quantity demand threshold is controlled to work in a rectification mode.

The balancing coil generates AC current, and the cell side coil forms a magnetic coupling, so that alternating voltage induced on the cell side coil is rectified. The rectified DC current charges the cell with low electricity quantity.

As shown in FIG. 3, in an embodiment of the present disclosure, the following steps are further included.

At step 330, a second working condition of the electricity quantity balancing is determined when the electricity quantity of one of the two associated cells corresponding to the cell electricity quantity balancing module is lower than a lower limit of the electricity quantity demand threshold and the electricity quantity of the other cell is higher than an upper limit of the electricity quantity demand threshold.

At step 340, the DC/AC converter corresponding to the cell side coil of the associated cell below the electricity quantity demand threshold is controlled to work in the rectification mode through the cell electricity quantity balancing module according to the second working condition, and the DC/AC converter corresponding to the cell side coil of the associated cell above the electricity quantity demand threshold is controlled to work in the inverter mode.

Energy is transmitted through the magnetic coupling of two cell side coils to achieve the electricity quantity balancing.

As shown in FIG. 3, in an embodiment of the present disclosure, the following steps are further included.

At step 350, a third working condition of the electricity quantity balancing is determined when the electricity quantity of the two associated cells corresponding to the cell electricity quantity balancing module is higher than the electricity quantity demand threshold.

At step 360, DC/AC converters of cell side coils of the two associated cells are controlled to respectively work in the inverter mode through the cell electricity quantity balancing module according to the third working condition, and the DC/AC converter corresponding to the balancing coil is controlled to work in the rectification mode.

Excess energy of the cell is inverted to the 24V direct current bus through the magnetic coupling. The excess energy is used to charge other cells that need to be recharged on the 24V bus or to be supplied to other 24V devices.

The cell electricity quantity balancing method in the embodiments of the present disclosure associates the electricity quantity deviation cell with the electricity quantity balancing process of the associated cell, forming a distinction to a local electricity quantity balancing working condition. Additionally, according to the working condition, a control logic of each DC/AC converter is formed to achieve maximum energy utilization and balancing efficiency during the electricity quantity balancing process.

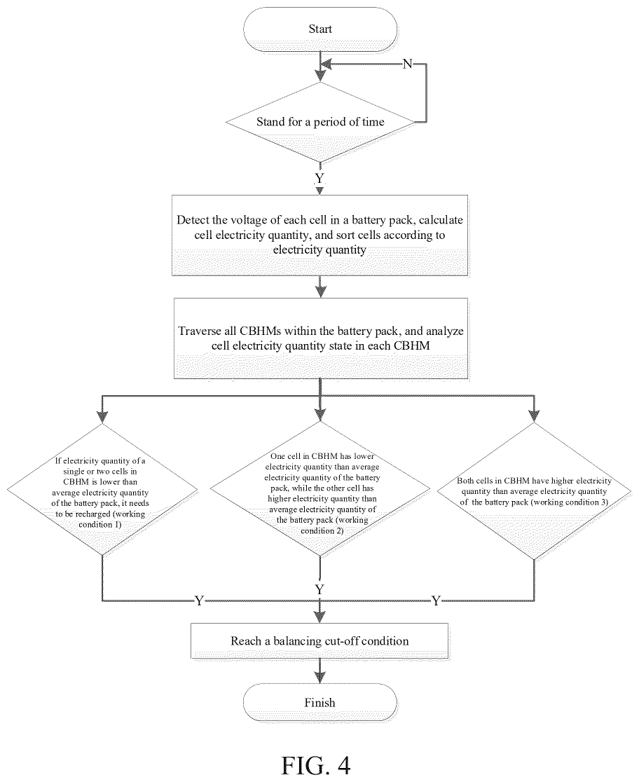

The practical application of a cell electricity quantity balancing method in an embodiment of the present disclosure is shown in FIG. 4. In FIG. 4, when the battery pack is left to stand for a period of time, a polarization phenomenon of the cell basically disappears. At this time, the voltage of each cell in the battery pack is detected to calculate the electricity quantity of each cell. The cells in the battery pack are sorted according to the cell electricity quantity. Then the cell electricity quantity balancing module is used as a unit, and cell electricity quantity status controlled through each cell electricity quantity balancing module is analyzed. The balancing working condition suitable for each cell electricity quantity balancing module is selected from working conditions 1 to 3. When a certain cell electricity quantity balancing module reaches the balancing cut-off condition, balancing control of the cell electricity quantity balancing module is stopped.

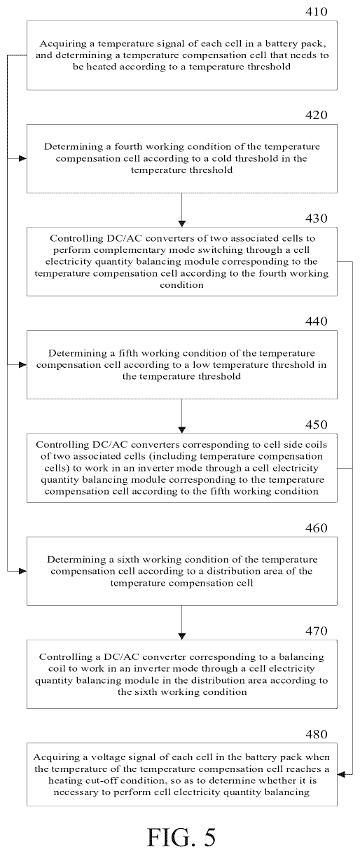

A cell heating method in an embodiment of the present disclosure is shown in FIG. 5. In FIG. 5, the embodiments of the present disclosure utilize the cell electricity quantity balancing module according to the above embodiments, including the following steps.

At step 410, a temperature signal of each cell in a battery pack is acquired, and a temperature compensation cell that needs to be heated is determined according to a temperature threshold.

The temperature threshold includes a gradient threshold, including but not limited to a cold threshold that causes the cell to approach failure and a low temperature threshold that causes the cell to approach inefficiency.

At step 420, a fourth working condition of the temperature compensation cell is determined according to a cold threshold in the temperature threshold.

At step 430, DC/AC converters of two associated cells (including temperature compensation cells) are controlled to perform complementary mode switching through a cell electricity quantity balancing module corresponding to the temperature compensation cell according to the fourth working condition.

The complementary mode switching means that the DC/AC converter corresponding to the cell side coil of one associated cell works in the inverter mode while the DC/AC converter corresponding to the cell side coil of the other associated cell works in the rectification mode. High frequency mode switching will apply AC current of appropriate amplitude and frequency parameters to the cell to heat the cell without damaging it.

As shown in FIG. 5, in an embodiment of the present disclosure, the following steps are further included.

At step 440, a fifth working condition of the temperature compensation cell is determined according to a low temperature threshold in the temperature threshold; and

At step 450, DC/AC converters corresponding to cell side coils of two associated cells (including temperature compensation cells) are controlled to work in an inverter mode through a cell electricity quantity balancing module corresponding to the temperature compensation cell according to the fifth working condition.

The inverter mode causes the cell side coil to generate high-frequency alternating current, and heats up the cell coil by means of discharging using the cell to raise the temperature of the cell.

As shown in FIG. 5, in an embodiment of the present disclosure, the following steps are further included.

At step 460, a sixth working condition of the temperature compensation cell is determined according to a distribution area of the temperature compensation cell.

At step 470, a DC/AC converter corresponding to a balancing coil is controlled to work in an inverter mode through a cell electricity quantity balancing module in the distribution area according to the sixth working condition.

The inverter mode causes the balancing coil to generate the high-frequency alternating current, and uses internal resistance of the balancing coil to heat it up to raise the temperature of the cell when heat is transmitted to the associated cell.

As shown in FIG. 5, in an embodiment of the present disclosure, the following step is further included.

At step 480, a voltage signal of each cell in the battery pack is acquired when the temperature of the temperature compensation cell reaches a heating cut-off condition, so as to determine whether it is necessary to perform cell electricity quantity balancing.

A cell electricity quantity balancing apparatus in an embodiment of the present disclosure includes:
a memory configured to store a program code corresponding to processing procedures of the above cell electricity quantity balancing method and cell heating method; and
a processor configured to execute the program code corresponding to the processing procedures of the above cell electricity quantity balancing method and cell heating method.

The processor can adopt a digital signal processor (DSP), a field programmable gate array (FPGA), a microcontroller unit (MCU) system board, a system on a chip (SoC) system board, or a programmable logic controller (PLC) minimum system including I/O.

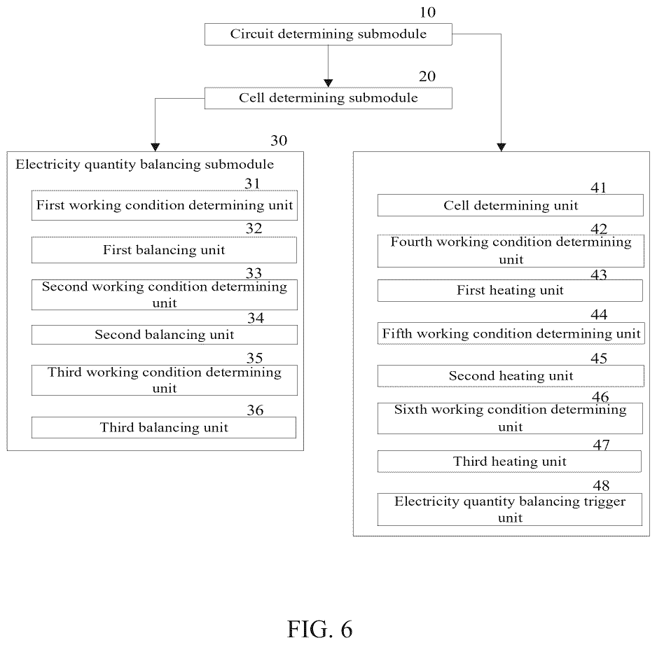

A cell electricity quantity balancing apparatus in an embodiment of the present disclosure is shown in FIG. 6. In FIG. 6, implementation of the present disclosure includes:
a circuit determining submodule 10 configured to determine a cell electricity quantity balancing module provided between paired associated cells;
a cell determining submodule 20 configured to acquire a voltage signal of each cell in a battery pack, and determine an electricity quantity deviation cell that needs to balance electricity quantity according to an electricity quantity balancing strategy; and
an electricity quantity balancing submodule 30 configured to locate a corresponding cell electricity quantity balancing module according to the electricity quantity deviation cell, and control a cell electricity quantity balancing module to perform cell electricity quantity balancing at the same time according to a voltage working condition of the associated cell until a balancing cut-off condition is met.

As shown in FIG. 6, in an embodiment of the present disclosure, the electricity quantity balancing submodule 30 includes:
a first working condition determining unit 31 configured to determine a first working condition of electricity quantity balancing when electricity quantity of at least one of two associated cells corresponding to a cell electricity quantity balancing module is lower than an electricity quantity demand threshold; and
a first balancing unit 32 configured to control a DC/AC converter corresponding to a balancing coil to work in an inverter mode through the cell electricity quantity balancing module according to the first working condition, and control the DC/AC converter corresponding to a cell side coil of the associated cell below the electricity quantity demand threshold to work in a rectification mode.

As shown in FIG. 6, in an embodiment of the present disclosure, further including:
a second working condition determining unit 33 configured to determine a second working condition of electricity quantity balancing when electricity quantity of one of two associated cells corresponding to a cell electricity quantity balancing module is lower than a lower limit of an electricity quantity demand threshold and the electricity quantity of the other cell is higher than an upper limit of the electricity quantity demand threshold; and
a second balancing unit 34 configured to control a DC/AC converter corresponding to a cell side coil of an associated cell below the lower limit of the electricity quantity demand threshold to work in a rectification mode through the cell electricity quantity balancing module according to the second working condition, and control the DC/AC converter corresponding to the cell side coil of the associated cell above the upper limit of the electricity quantity demand threshold to work in an inverter mode.

As shown in FIG. 6, in an embodiment of the present disclosure, further including:
a third working condition determining unit 35 configured to determine a third working condition of electricity quantity balancing when electricity quantity of two associated cells corresponding to a cell electricity quantity balancing module is higher than an electricity quantity demand threshold; and
a third balancing unit 36 configured to control DC/AC converters of cell side coils of the two associated cells to work in an inverter mode and to control the DC/AC converters corresponding to balancing coils to work in a rectification mode, respectively, through the cell electricity quantity balancing module according to the third working condition.

As shown in FIG. 6, in an embodiment of the present disclosure, further including:
a cell determining unit 41 configured to acquire a temperature signal of each cell in a battery pack, and determine a temperature compensation cell that needs to be heated according to a temperature threshold;
a fourth working condition determining unit 42 configured to determine a fourth working condition of the temperature compensation cell according to a cold threshold in the temperature threshold; and
a first heating unit 43 configured to control DC/AC converters of two associated cells (including temperature compensation cells) to perform complementary mode switching through a cell electricity quantity balancing module corresponding to the temperature compensation cell according to the fourth working condition.

As shown in FIG. 6, in an embodiment of the present disclosure, further including:
a fifth working condition determining unit 44 configured to determine a fifth working condition of a temperature compensation cell according to a low temperature threshold in a temperature threshold; and
a second heating unit 45 configured to control DC/AC converters corresponding to cell side coils of two associated cells (including temperature compensation cells) to work in an inverter mode through a cell electricity quantity balancing module corresponding to the temperature compensation cell according to the fifth working condition.

As shown in FIG. 6, in an embodiment of the present disclosure, further including:
a sixth working condition determining unit 46 configured to determine a sixth working condition of a temperature compensation cell according to a distribution area of the temperature compensation cell; and
a third heating unit 47 configured to control a DC/AC converter corresponding to a balancing coil to work in an inverter mode through a cell electricity quantity balancing module in the distribution area according to the sixth working condition.

As shown in FIG. 6, in an embodiment of the present disclosure, further including:
an electricity quantity balancing trigger unit 48 configured to acquire a voltage signal of each cell in a battery pack when the temperature of a temperature compensation cell reaches a heating cut-off condition, and determine whether it is necessary to perform cell electricity quantity balancing.

The above are merely preferred specific implementation manners of the present disclosure, but the protection scope of the present disclosure is not limited thereto. Any variations or replacements that may be envisaged by those skilled in the art within the technical scope disclosed in the present disclosure also fall within the protection scope of the present disclosure. Therefore, the protection scope of the present disclosure should be based on the protection scope of the claims.

The embodiments of the present disclosure provide an electronic device. At a hardware level, the electronic device includes a processor, and optionally further includes an internal bus, a network interface, and a memory. Among them, the memory may include internal storage, such as high-speed random-access memory (RAM), and may further include non-volatile memory, such as at least one disk memory. Of course, the electronic device may further include hardware required for other operations.

The processor, the network interface, and the memory may be interconnected through the internal bus. The internal bus may be an industry standard architecture (ISA) bus, a peripheral component interconnect (PCI) bus, or an extended industry standard architecture (EISA) bus. The bus may be divided into an address bus, a data bus, a control bus, or the like.

The memory is configured to store execution instructions. Specifically, an execution instruction is a computer program that may be executed. The memory may include both internal storage and non-volatile memory, and provide the execution instructions and data to the processor.

In a possible implementation manner, the processor reads the corresponding execution instructions from the non-volatile memory into the internal storage and then runs them, or the processor may also acquire the corresponding execution instructions from other devices to form a vascular segmentation apparatus at a logical level. The processor executes the execution instructions stored in the memory to achieve the cell electricity quantity balancing method and the cell heating method provided in any one of the embodiments of the present disclosure through the executed execution instructions.

The above cell electricity quantity balancing method and cell heating method provided in the embodiments of the present disclosure may be applied to the processor or implemented by the processor. The processor may be an integrated circuit chip with signal processing capabilities. During an implementation process, each step of the above method may be completed by integrated logic circuits in hardware in the processor or by instructions in the form of software. The above processor may be a general-purpose processor, including a central processing unit (CPU), a network processor (NP), or the like. It may also be a digital signal processor (DSP), an application specific integrated circuit (ASIC), a field programmable gate array (FPGA), or other programmable logic devices, discrete gates or transistor logic devices, or discrete hardware components. The disclosed methods, steps, and logical diagrams in the embodiments of the present disclosure may be implemented or performed. The general-purpose processor may be a microprocessor or any conventional processor.

The steps of the method disclosed combined with the embodiments of the present disclosure may be directly embodied as being performed by a hardware decoding processor, or performed by a combination of hardware in a decoding processor and software modules. The software modules may be located in a mature storage medium in the art, such as random-access memory, flash memory, read-only memory, programmable read-only memory, or electrically erasable programmable memory, and register. The storage medium is located in the memory, and the processor reads information from the memory and completes the steps of the above method combined with the hardware thereof.

### INDUSTRIAL APPLICABILITY

The present disclosure provides a cell electricity quantity balancing module, an electricity quantity balancing method, and a heating method and an apparatus. According to a principle of wireless power transmission (WPT), isolation between coils is adopted instead of an isolation transformer to construct a new charging and discharging structure for an entire battery pack to achieve multi-channel simultaneous electricity quantity balancing, thereby effectively avoiding drawbacks of large balancing heating and few active balancing channels. At the same time, each coil in the module may cooperate with each other to heat a cell, thereby achieving independent and accurate temperature control and ensuring temperature uniformity of the entire battery pack. The generated product may be mass-produced for rapid application in systems or scenarios with a high demand for the battery pack.

1: A cell electricity quantity balancing module, comprising two cell side coils, a balancing coil, and three DC/AC converters corresponding to coils, wherein an AC terminal of a first DC/AC converter is connected in parallel with one cell side coil, and a DC terminal is connected in parallel with positive and negative poles of a first adjacent cell; an AC terminal of a second DC/AC converter is connected in parallel with the other cell side coil, and a DC terminal is connected in parallel with positive and negative poles of a second adjacent cell; an AC terminal of a third DC/AC converter is connected in parallel with the balancing coil, and a DC terminal is connected in parallel with a direct current bus; and the two cell side coils are located on both sides of the balancing coil, and the cell side coil is bonded to the balancing coil in an insulated manner.

2: A cell electricity quantity balancing method, comprising:
determining a cell electricity quantity balancing module provided between paired associated cells;
acquiring a voltage signal of each cell in a battery pack, and determining an electricity quantity deviation cell that needs to balance electricity quantity according to an electricity quantity balancing strategy; and
locating a corresponding cell electricity quantity balancing module according to the electricity quantity deviation cell, and controlling the cell electricity quantity balancing module to perform cell electricity quantity balancing at the same time according to a voltage working condition of the associated cell until a balancing cut-off condition is met.

3: The cell electricity quantity balancing method according to claim 2, wherein controlling the cell electricity quantity balancing module to perform the cell electricity quantity balancing at the same time according to the voltage working condition of the associated cell comprises:
determining a first working condition of electricity quantity balancing when the electricity quantity of at least one of the two associated cells corresponding to the cell electricity quantity balancing module is lower than an electricity quantity demand threshold; and
controlling a DC/AC converter corresponding to a balancing coil to work in an inverter mode through the cell electricity quantity balancing module according to the first working condition, and controlling the DC/AC converter corresponding to a cell side coil of the associated cell below the electricity quantity demand threshold to work in a rectification mode.

4: The cell electricity quantity balancing method according to claim 2, wherein controlling the cell electricity quantity balancing module to perform the cell electricity quantity balancing at the same time according to the voltage working condition of the associated cell comprises:
determining a second working condition of the electricity quantity balancing when the electricity quantity of one of the two associated cells corresponding to the cell electricity quantity balancing module is lower than a lower limit of the electricity quantity demand threshold and the electricity quantity of the other cell is higher than an upper limit of the electricity quantity demand threshold; and
controlling the DC/AC converter corresponding to the cell side coil of the associated cell below the electricity quantity demand threshold to work in the rectification mode through the cell electricity quantity balancing module according to the second working condition, and controlling the DC/AC converter corresponding to the cell side coil of the associated cell above the electricity quantity demand threshold to work in the inverter mode.

5: The cell electricity quantity balancing method according to claim 2, wherein controlling the cell electricity quantity balancing module to perform the cell electricity quantity balancing at the same time according to the voltage working condition of the associated cell comprises:
determining a third working condition of the electricity quantity balancing when the electricity quantity of the two associated cells corresponding to the cell electricity quantity balancing module is higher than the electricity quantity demand threshold; and
controlling DC/AC converters of cell side coils of the two associated cells to respectively work in the inverter mode through the cell electricity quantity balancing module according to the third working condition, and controlling the DC/AC converter corresponding to the balancing coil to work in the rectification mode.

6: A cell heating method, comprising:
acquiring a temperature signal of each cell in a battery pack, and determining a temperature compensation cell that needs to be heated according to a temperature threshold;
determining a fourth working condition of the temperature compensation cell according to a cold threshold in the temperature threshold; and
controlling DC/AC converters of two associated cells to perform complementary mode switching through a cell electricity quantity balancing module corresponding to the temperature compensation cell according to the fourth working condition.

7: The cell heating method according to claim 6, further comprising:
acquiring a voltage signal of each cell in the battery pack when the temperature of the temperature compensation cell reaches a heating cut-off condition, so as to determine whether it is necessary to perform cell electricity quantity balancing.

8: A cell heating method, comprising:
acquiring a temperature signal of each cell in a battery pack, and determining a temperature compensation cell that needs to be heated according to a temperature threshold;
determining a fifth working condition of the temperature compensation cell according to a low temperature threshold in the temperature threshold; and
controlling DC/AC converters corresponding to cell side coils of two associated cells to work in an inverter mode through a cell electricity quantity balancing module corresponding to the temperature compensation cell according to the fifth working condition.

9: The cell heating method according to claim 8, further comprising:
acquiring a voltage signal of each cell in the battery pack when the temperature of the temperature compensation cell reaches a heating cut-off condition, so as to determine whether it is necessary to perform cell electricity quantity balancing.

10: A cell heating method, comprising:
acquiring a temperature signal of each cell in a battery pack, and determining a temperature compensation cell that needs to be heated according to a temperature threshold;
determining a sixth working condition of the temperature compensation cell according to a distribution area of the temperature compensation cell; and
controlling a DC/AC converter corresponding to a balancing coil to work in an inverter mode through a cell electricity quantity balancing module in the distribution area according to the sixth working condition.

11: A cell electricity quantity balancing apparatus, comprising:
a circuit determining submodule configured to determine a cell electricity quantity balancing module provided between paired associated cells;
a cell determining submodule configured to acquire a voltage signal of each cell in a battery pack, and determine an electricity quantity deviation cell that needs to balance electricity quantity according to an electricity quantity balancing strategy; and
an electricity quantity balancing submodule configured to locate a corresponding cell electricity quantity balancing module according to the electricity quantity deviation cell, and control a cell electricity quantity balancing module to perform cell electricity quantity balancing at the same time according to a voltage working condition of the associated cell until a balancing cut-off condition is met.

12: A readable medium, wherein the readable medium comprises execution instructions, when executed by a processor of an electronic device, the electronic device performs the method according to claim 2.

13: An electronic device, comprising a processor and a memory storing execution instructions, wherein when the execution instructions stored in the memory are executed by the processor, the processor performs the method according to claim 2.
